(19) United States
(12) Patent Application Publication
(10) Pub. No.: US 2009/0286511 A1
(43) Pub. Date: Nov. 19, 2009

(54) Granting And Use Of Rights Over A Telecommunications Network

(76) Inventors: Stéphane Petit, Herouville Saint Clair (FR); Francois Boudet, Fierville Bray (FR)

Correspondence Address: COHEN, PONTANI, LIEBERMAN & PAVANE LLP, 551 FIFTH AVENUE, SUITE 1210, NEW YORK, NY, 10176, US

(21) Appl. No.: 11/791,436

(22) PCT Filed: Oct. 21, 2005
(86) PCT No.: PCT/FR2005/002634

§ 371 Date: May 21, 2007

(30) Foreign Application Priority Data
Nov. 23, 2004 (FR) 0412500

(51) Int. Cl. H04M 1/66

(52) U.S. Cl. 455/411

(57) ABSTRACT

A mechanism for granting and exercising a right by means of a portable object (MOB), said portable object comprising means for communicating with a telecommunication network, said portable object (MOB) being adapted to receive a right that can be checked by a verification device (VRF). The method comprises the following steps: the portable object (MOB) sending said right to a portable module (MSC); storing said right in said portable module (MSC); and verification of said right by a verification device (VRF) adapted to read the rights stored in the module (MSC) in order to verify the validity of said right.

### TECHNICAL FIELD

The invention relates to a mechanism for granting and exercising rights via a telecommunications network.

The invention relates more particularly to the use of portable objects to store rights that can be checked by a third party. A right may be a right to access a secure area, a right to park in a parking space of a car park, or any other right that is checked.

The portable objects in question may be mobile telephones, PDA (personal digital assistants), laptop computers, or any other means able to communicate with a network. The portable object selected to illustrate the invention is a mobile telephone.

The portable object may communicate over any network. This network may be a long-range network (for example a GSM network or the Internet) or a short-range network (for example a Bluetooth, infrared, WiFi, RFID (radio-frequency identification), etc. network).

### PRIOR ART

Mobile telephones offer numerous services such as logical security services like authentication; they can therefore support payment services or services for controlling access to controlled areas.

A number of applications enable rights to be downloaded into a mobile telephone from a server. The validity of the rights is then verified in order to access a service.

Moreover, a number of mobile telephones are equipped with short-range communication means. Thus a person in possession of a mobile telephone storing a right of access may go to the entrance of a secure area and send a message including that right of access for verification, for example to a station provided for that purpose. When the telephone is present in front of the station, the station receives the right associated with the telephone and verifies whether it grants the right to access the controlled area. If so, the proprietor of the telephone is authorized to enter that area.

The problem is that the rights can be checked only in the presence of the mobile telephone, which requires its proprietor never to be separated from it. This constraint limits the number of possible applications using a mobile telephone to store rights.

### THE INVENTION

An object of the invention is to make it possible to store rights in a mobile telephone and at the same time to make it possible to check that information in the absence of the telephone and the proprietor of the telephone, and all this with maximum security at the time of exercising the stored rights.

To this end, according to the invention, the portable object transmits a right to a portable module in order to be stored therein, said module being adapted to receive a right from said portable object and to communicate with a control device adapted to read that right and to verify its validity.

Thus each portable object is associated with one or more portable modules. These modules are intelligent extensions of the memory of the portable object that enable the portable object to serve as a relay between an application server granting rights and one or more portable modules associated with the portable object.

Transfer of rights between the mobile telephone and a portable module is advantageously effected in a secure manner using a cryptographic algorithm. The rights are therefore transferred from the portable object to a module with a level of security guaranteeing that no malicious third party intercepts those rights for fraudulent use.

The invention can be better understood on reading the following description, which is given by way of example and with reference to the appended drawings. In the figures, in order to simplify the description, the same items carry the same references.

### THE FIGURES

FIG. 1 shows a first electronic data processing system in which the invention may be used. This figure also shows the steps of the method illustrating one implementation of the invention relating to the right to park in a parking space.

FIG. 2 shows the method, illustrating this first implementation in the form of an algorithm.

FIG. 3 shows a second electronic data processing system in which the invention may be used. This figure illustrates the steps of a second implementation of the invention relating to parking, and more particularly to the management of penalties if the right stored in the module is invalid.

FIG. 4 shows the steps of the method illustrating this second implementation in the form of an algorithm.

### DETAILED DESCRIPTION OF EMBODIMENTS ILLUSTRATING THE INVENTION

FIG. 1 represents an electronic data processing system SYS including a portable object MOB communicating via a network with a rights server SERV1 adapted to grant rights. In this embodiment, the portable object MOB is a mobile telephone.

The communication protocol used in this embodiment is the wireless application protocol (WAP) that enables access to the Internet via a mobile telephone.

The rights server SERV1 may be a server providing services such as a service that grants the right to park in a parking space, for example. The user indicates to the server the parking space selected for the vehicle and the required parking times for example. The user receives in return a message including a right to that space. That right is preferably then stored temporarily in a memory of the telephone MOB.

In this embodiment, the mobile telephone is coupled to a subscriber identity module (SIM) card. The invention may nevertheless be implemented in a telephone that is not equipped with a SIM card.

The mobile telephone MOB contains one or more cryptographic algorithms for authenticating the telephone/card combination and/or the telephone/rights server combination. The cryptographic algorithm is either symmetrical or asymmetrical. It is chosen according to the required level of security.

According to the invention, the mobile telephone MOB communicates with at least one portable module MSC. A portable module MSC is an electronic medium adapted to communicate with the mobile telephone MOB and with a rights verification device VRF.

According to the invention, the mobile telephone MOB transmits the right to a portable module to be stored therein. Said module comprises means for receiving the right and means for communicating with the verification device VRF which is thus able to verify whether the right stored in the portable module MSC is valid. If the right is not valid, the verification device VRF detects this and takes action. That action may equally be issuing a penalty for unauthorized parking, or prohibiting entry to a controlled area. If the right is valid, the verification device VRF authorizes access to the service.

The module MSC may be equipped with contacts for connecting it to the telephone. However, for ease of use, the coupling between the module MSC and the telephone MOB is contactless in this embodiment.

In the example shown, the contactless module MSC comprises the following elements:
a memory adapted to store data, in particular data identifying the mobile telephone with which the module MSC is associated; this memory is a non-volatile memory, for example an EEPROM, and the contents of a module MSC can therefore be deleted and re-used;
writing means adapted to write received data in the memory;
means for sending and receiving signals, such as a radio-frequency antenna:
for sending signals to the verification device VRF;
for receiving signals from the mobile telephone MOB and the verification device VRF;
a microcontroller including a program for processing data, in particular for processing data received and to be transmitted.

The module MSC may be passive or active. Unlike a passive contactless card, an active contactless card contains its own power supply.

In this example, all communications are locally secured by means of cryptographic algorithms, in particular authentication algorithms. An authentication algorithm is a process aiming to establish in a formal and intangible manner the identities of the parties to an electronic transaction or communication. This process involves the parties confirming and validating their identification by technical means, such as passwords, or responding to a challenge when using a strong authentication procedure (challenge/response), known in the art.

The rights server SERV1 therefore includes cryptographic means for authenticating the mobile telephone MOB and setting up secure communication with it.

The rights server SERV1 includes cryptographic means for authenticating the verification device VRF and setting up secure communication with it. The verification device VRF includes a communication interface for dialogue with the rights server SERV1.

Any type of link may be used between the rights server SERV1 and the verification device VRF, and this link may be a cable link, a long-range (RTC, IP) link or a medium-range (a few meters) link.

In the example shown, the contactless module MSC also includes short-range (for example around ten centimeters) means for communicating with one or more verification devices VRF (this is the same interface used to communicate with the mobile). In the same way, in this example, the verification device VRF includes short-range communication means for communicating with the contactless module MSC.

In this embodiment, the mobile telephone includes a man-machine interface with its proprietor and a short-range interface with one or more contactless modules MSC. In the same way, the contactless module MSC preferably includes means for short-range communication with the mobile telephone MOB.

The verification device VRF may include a man-machine interface that an operative responsible for verifying rights may use, for example. It may also be coupled to a physical access control system such as a motorway toll gate barrier.

The mobile telephone MOB also comprises means for writing rights in the memory of the contactless module MSC by sending a signal to the module MSC, which receives the signal by means of its antenna. In this example, the module authorizes writing only if it has been able to authenticate the mobile as the mobile that is authorized to write.

In this embodiment, the verification device VRF includes means for generating an electromagnetic field and can therefore activate the contactless module MSC and automatically read data contained in it. The contactless module MSC includes means for sending information to the verification device VRF in return, in the form of radio-frequency signals. On reception, the verification device converts the received signals into digital information usable by its microcontroller.

A mutual authentication algorithm is preferably used when a connection with the contactless module MSC must be set up. In this example, this mutual authentication therefore relates to communication between the module MSC and the mobile telephone MOB and to communication between the module MSC and the verification device VRF. Unlike simple authentication, mutual authentication involves each party authenticating the other.

The module MSC stores data in a structured way. It advantageously includes a plurality of memory areas for storing rights of different types. For example, one memory area may relate to a right to use a parking space. Another memory area may relate to a right of entry to a show, etc. The memory areas are preferably compartmented and logically sealed relative to each other, thereby enabling several services or levels of service to be supported.

The module MSC further includes means for managing the right to access the various memory areas corresponding to the various verification devices VRF with which the module MSC can dialogue. For example, if the verification device is a device adapted to verify a right to use a parking space, it is capable of identifying the corresponding memory area in the contactless module MSC and extracting the associated rights therefrom.

To give another example, if the device in question is a motorway toll gate barrier, the control logic of that barrier is adapted:
to detect the portable module MSC; and
to identify the memory area in question.

It is preferably possible to read a memory area dedicated to a verification device VRF and only that area only after mutual verification.

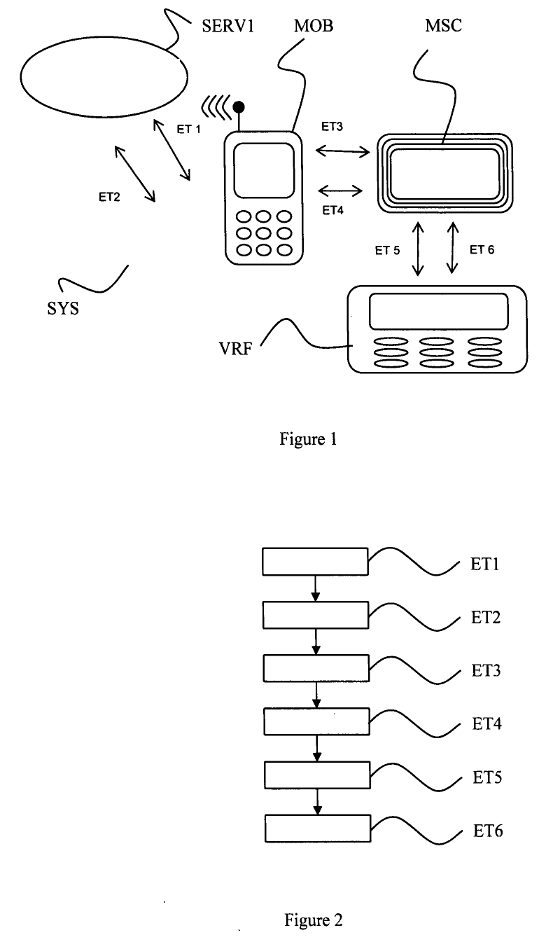

FIG. 2 shows an algorithm representing the steps of the method executed in the system described with reference to FIG. 1. FIG. 1 also includes references to those steps to assist in identifying the sender and the receiver of each message.

For use of this system in the context of chargeable parking, for example, the method functions in the following manner:
In a first step ET1, the mobile telephone contacts the service that grants parking rights by connecting to the rights server SERV1 by means of a man-machine interface and using its long-range communication mode.
In a second step ET2, after authentication of the telephone MOB by the rights server SERV1, the server SERV1 may exchange with the mobile telephone MOB data relating to the right to park and send the mobile telephone a right to park in a parking space. The right to park is preferably certified by a certification authority.
In a third step ET3, the mobile telephone contacts the contactless module MSC and proceeds to a first mutual authentication with the module MSC.
In a fourth step ET4, if the mutual authentication succeeds, the mobile telephone MOB sends the contactless module MSC the parking right received from the rights server in the second step; if the memory of the module MSC is compartmented into memory areas, the received right to park is stored in the memory area dedicated to parking. Otherwise, if the mutual authentication does not succeed, no communication can be set up between the mobile telephone MOB and the module MSC.
In a fifth step ET5, the verification device VRF contacts the contactless module MSC and proceeds to a mutual authentication.
If that authentication succeeds, the verification device VRF can access the memory area dedicated to parking rights.
Otherwise, if the mutual authentication does not succeed, no communication can be set up between the verification device VRF and the module MSC.
In a sixth step ET6, if the mutual authentication in the step ET5 succeeds, the verification device VRF receives the right to park from the contactless module MSC and verifies its characteristics. If the right is valid, the operative does not issue a penalty. Otherwise, if the right is not valid, the operative can report the violation in the conventional way by issuing a paper format penalty. The violation can also be reported using a second implementation of the invention described below.

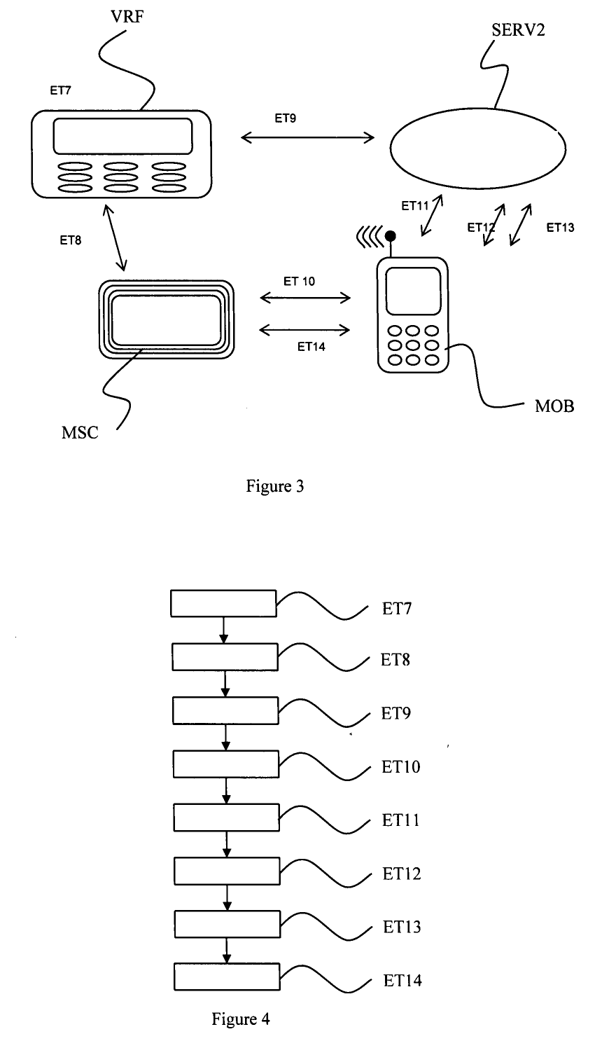

FIG. 3 shows the second implementation. Reference is also made to FIG. 4, which shows an algorithm representing the series of steps illustrating this example.

This implementation requires an additional second server to manage penalties, called the penalties server SERV2. Note that as a function of the possible applications of the invention, the servers SERV1 and SERV2 may be one and the same. For example, if the entity that grants a right also verifies the right, granting and verification of the right may be managed by the same server.

In this implementation, the mobile telephone MOB communicates with this penalties server SERV2 and is equipped with payment means and therefore with a payment protocol for dialogue with the penalties server SERV2. That protocol is ideally a secure protocol.

In this example, the verification device VRF includes means for long-range communication with the penalties server SERV2. It ideally has access to cryptographic means for mutual authentication with the penalties server. The verification device VRF may include a man-machine interface enabling a user to enter and receive information.

The penalties server SERV2 may communicate securely with different verification devices VRF. It can store and manage data linked to moving traffic violations and use a secure payment protocol compatible with mobile telephones.

In the example, the contactless module MSC preferably comprises a memory area dedicated to penalties.

The steps of the second embodiment of the method are shown in FIG. 4. The following steps may constitute a continuation of the steps ET1-ET6 previously shown:
In a seventh step ET7, the user of the verification device VRF, generally an operative, notes the violation. This may be simply visual, for example if the vehicle is badly parked. After mutual authentication allowing reading of the contactless module MSC, the operative may also verify whether the rights stored therein are valid (cf. ET6). For example, for a better assessment of the violation, the authorized parking period for the vehicle could also be read in this memory area, along with the registration number of the vehicle, the address of the owner and special characteristics such as a disability of the driver.
In one implementation of the invention, in an eighth step ET8, the verification device VRF communicates with the contactless module MSC and proceeds to effect a mutual authentication (if this was not done in the step ET7). If the authentication succeeds, the verification device VRF writes the characteristics of the violation in the memory area reserved for this purpose, preferably accompanied by an electronic signature.

In a ninth step ET9, the verification device VRF sends the penalties server SERV2 the characteristics of the penalty, for example by means of secure long-range communication, and preferably accompanied by its electronic signature.

Note that the order in which the steps ET8 and ET9 are executed is immaterial.
In a tenth step ET10, if the contactless module MSC can communicate securely with the mobile telephone MOB, following mutual authentication with the module MSC the mobile telephone MOB reads the certified characteristics of the penalty in the memory area reserved for the ticket and preferably stores them in a temporary memory.
In an eleventh step ET11, after storing the characteristics of the penalty, the mobile phone MOB contacts the penalties server SERV2 and transmits the penalty to it, accompanied by its electronic signature.
In a twelfth step ET12, the penalties server SERV2 authenticates the mobile telephone MOB and uses a protocol for remote payment by means thereof.
In a thirteenth step ET13, the penalties server SERV2 sends the mobile telephone MOB an electronic certificate of payment of the penalty.
In a fourteenth step ET14, after receiving this certificate, and by means of secure short-range communication with the contactless module MSC, the mobile telephone MOB deletes the data stored in the module relating to the violation, if appropriate. This function is of benefit if the number of bytes allocated to the memory area is not very large.

With reference to monitoring chargeable parking, the contactless module MSC may remain in the vehicle or even be incorporated into the components of the vehicle (for example the windshield). Once parking rights have been acquired using the mobile telephone, they are transferred to the contactless module MSC attached to the vehicle and verification is simply effected by holding the verification device VRF up to the windshield.

Moreover, the module preferably retains the right received in its storage means temporarily. Thus once the right has become invalid, for example when the period for using the right has ended, the right is deleted from the memory.

The use of the invention is not limited to the two embodiments described above. The principle of the invention may extend to any application in which rights must be verified.

As indicated above, a module MSC could support a plurality of separate memory areas; it is therefore possible to store other data with different access rights, including identification data of the vehicle such as data relating to the registration document or data relating to technical inspection. Moreover, a module MSC can store the official papers associated with driving a vehicle.

The invention is generally concerned with a method of granting and exercising a right via a portable object MOB. As already indicated, the method comprises the following steps:
a step of the portable object MOB sending the right to a portable module MSC;
a step of storing said right in said portable module MSC;
a step of verifying said right by a verification device adapted to read the rights stored in the module MSC to verify the validity of the right.

The invention also relates to the portable module MSC. That module comprises:
receiver means adapted to receive the right associated with the portable object MOB;

storage means adapted to store the received right;

sender means adapted to send the stored right to said verification device VRF for verifying the validity of said right.

The invention further relates to the portable object MOB. That portable object is characterized in that it comprises means for sending a right to a portable module adapted to store said right, which can be verified by a verification device for verifying the validity of said right.

The invention further relates to a verification device VRF comprising means for communicating with a portable module MSC, reading means adapted to read a right in the module MSC, and verification means for verifying the validity of said right.

The invention further relates to the computer program adapted to be executed in a portable object MOB. That program includes code instructions which, when the program is executed in said portable object, effect a step of sending the right to a portable module adapted to store said right, which can thereafter be verified by a verification device for verifying the validity of said right.

The invention further relates to the computer program adapted to be executed in the above portable module MSC. That program comprises code instructions which, when the program is executed in said portable module MSC, executes the following steps:
a reception step adapted to receive the right associated with the portable object;
a storage step of storing the received right;
a sending step of sending the stored right to a verification device for checking the validity of the right.

It can therefore be seen that, apart from the main advantage of being able to export rights from the mobile telephone to memory extensions consisting of contactless modules MSC, the invention also has other advantages.

For example, we have seen that the module includes means for verifying the right of the portable object MOB to write a right in said module MSC. It also includes means for verifying the right of said verification device VRF to read a right in said module MSC. Thus only the approved portable object MOB or the approved verification device VRF can access the data stored in the module MSC.

We have also seen that the module includes storage means compartmented into a plurality of memory areas and that the verification of rights is applied to the areas taken in isolation. This enables rights relating to different applications to be stored in the same module MSC.

Moreover, the memory areas are compartmented and logically sealed from each other. This makes supporting a plurality of services or levels of service stored in respective areas of the same module MSC totally secure.

We have further seen that the module MSC includes means for establishing a correspondence between a memory area and a respective set of portable objects authorized to access the content of that memory area. Thus the module MSC can verify that the portable object seeking to access the area storing a right has an identifier stored in its storage means and that the portable object concerned is the object that is authorized to communicate with this memory area of the module MSC.

The module holds the right received in its storage means temporarily. Thus the right can be used only a limited number of times or for a predetermined period.

It is clear that, by means of the invention, e.g. when ticketing, the group ticket concept is simplified, whether that ticket is a ticket to a show or a transport ticket, or some other application in which a right is to be granted to a plurality of members of a group. The tickets can be ordered and paid for from a single mobile telephone, and then distributed to various contactless modules MSC distributed to the members of the group, thus enabling them to use the individual verification process as described above with reference to FIG. 2.

1. A method of granting and exercising a right by means of a portable object (MOB), said portable object (MOB) including means for communicating with a telecommunication network, said portable object (MOB) being adapted to receive a right liable to be checked by a verification device (VRF), which method comprises the steps of:
the portable object (MOB) sending said right to a portable module (MSC);
storing said right in said portable module (MSC); and
verification of said right by a verification device (VRF) adapted to read the rights stored in the module (MSC) to verify the validity of said right.

2. A portable module (MSC) adapted to communicate with a portable object (MOB) and with a verification device (VRF), said portable object storing a right that can be verified by said verification device (VRF), wherein the portable module comprises:
receiver means adapted to receive the right associated with the portable object (MOB);
storage means adapted to store the received right; and
sender means adapted to send the stored right to said verification device (VRF) for verifying the validity of the right.

3. The module according to claim 2, comprising means for verifying the right of the portable object (MOB) to write a right in said module (MSC).

4. The module according to claim 2, comprising means for verifying the right of said verification device (VRF) to read a right in said module (MSC).

5. The module according to claim 2, comprising storage means compartmented into a plurality of memory areas and the verification of rights is applied to the areas taken in isolation.

6. The module according to claim 5, comprising means for establishing a correspondence between a memory area and a respective set of portable objects approved to access the content of that memory area.

7. The module according to claim 2, wherein the module is adapted to hold the received right in its storage means temporarily.

8. A portable object (MOB) adapted to receive rights that can be checked by a verification device (VRF), wherein the portable object comprises means for sending a right to a portable module (MSC) adapted to store said right, which can be verified by said verification device (VRF) for verifying the validity of said right.

9. A verification device (VRF) adapted to check a right granted by a portable module (MSC) as defined claim 2, wherein the verification device comprises:
means for communicating with the portable module (MSC);
reading means for reading the right stored in the module (MSC); and
verification means for verifying the validity of said right.

10. A computer program adapted to be used in a portable object (MOB) adapted to store a right, said program comprising code instructions which, when the program is executed in said portable object (MOB), execute a step of sending said right to a portable module (MSC) adapted to store the right, which can thereafter be verified by a verification device (VRF) for verifying the validity of said right.

11. A computer program adapted to be executed on a portable module (MSC) as defined in claim 2, said program comprising code instructions which, when the program is executed in said portable module (MSC), execute the steps of:
receiving the right associated with the portable object (MOB);
storing the received right; and
sending the stored right to a verification device (VRF) for checking the validity of the right.
